(19) United States
(12) Patent Application Publication
(10) Pub. No.: US 2002/0188647 A1
(43) Pub. Date: Dec. 12, 2002

(54) Method and apparatus for optimizing data transfers between processes

(76) Inventor: Mark A. Dovi, Sherwood, OR (US)

Correspondence Address: HEWLETT-PACKARD COMPANY, Intellectual Property Administration, P.O. Box 272400, Fort Collins, CO, 80527-2400, US

(21) Appl. No.: 09/879,314

(22) Filed: Jun. 12, 2001

(51) Int. Cl. G06F 9/00

(52) U.S. Cl. 709/101

(57) ABSTRACT

Data transfer between different computer programs or different computers can be optimized by tracking the performance of different data transfer pathways and selecting the particular pathway to use for future transfers according to user-specified rules or requirements. User-specified rules provide a metric or yardstick by which the data transfer pathway metrics can be evaluated in order to address their suitability to address their propriety for a data transfer pathway.

### FIELD OF THE INVENTION

This invention relates to data processing systems. In particular, this invention relates to a method and apparatus for providing efficient data transfers between two or more data processing applications as well as between two or more computers.

### BACKGROUND OF THE INVENTION

It is not uncommon in data processing systems to have two or more separate computer programs (also referred to or known as applications or processes) perform calculations on (also referred to as operating on) the same data. Different computer programs, which might run on the same physical computer or even different computers, also often operate on the same data to perform significantly different calculations or to provide significantly different information but nevertheless need to share or exchange the data between themselves.

In some prior art systems, data might be centrally stored in a file or data structure from which it is accessible by the different computer programs. In other instances, the data, might need to be physically or virtually transferred between processes, which is conceptually analogous to a physical transfer of the information.

Various prior art methodologies for transferring data between processes and processors add unnecessary processing overhead. A prior art data transfer method for sending data from one process (or processor) to another might require encryption, compression or other processing both prior and subsequent to transfer of the data between the processes. In prior art data processing systems, implementation and execution of security software, data compression software and possibly data formatting programs needlessly adds to system complexity and processing time overhead required by a computer (or computers) that actually performs the operations. Accordingly, there is a need for an expedited method and apparatus by which data can be transferred between and among unrelated computer programs to simplify system design and expedite system throughput.

### SUMMARY OF THE INVENTION

A method and apparatus for transferring data between different data processing applications heuristically determines data transfer metrics between the two or more processes, programs, applications or computers or networks and determines which of several possible data transfer pathways is best according to rules and requirements established by the user. The method and apparatus thereafter directs or limits the data transfer pathway between the data processes, programs, applications, computers or networks to the pathway(s) that is (are) best suited to accomplish the data transfer. In determining which data transfer pathway is best, a data transfer manager can use objective metrics in combination with user-defined rules or protocols to follow.

### BRIEF DESCRIPTION OF THE DRAWINGS

FIG. 1 shows a simplified block diagram of multiple processes running within a single computer. FIG. 1 also represents multiple computers running different applications.

FIG. 2 depicts a simplified flow chart of a process by which a particular pathway of two or more different pathways for transferring data between two applications can be identified or chosen.

### DETAILED DESCRIPTION OF THE PREFERRED EMBODIMENT

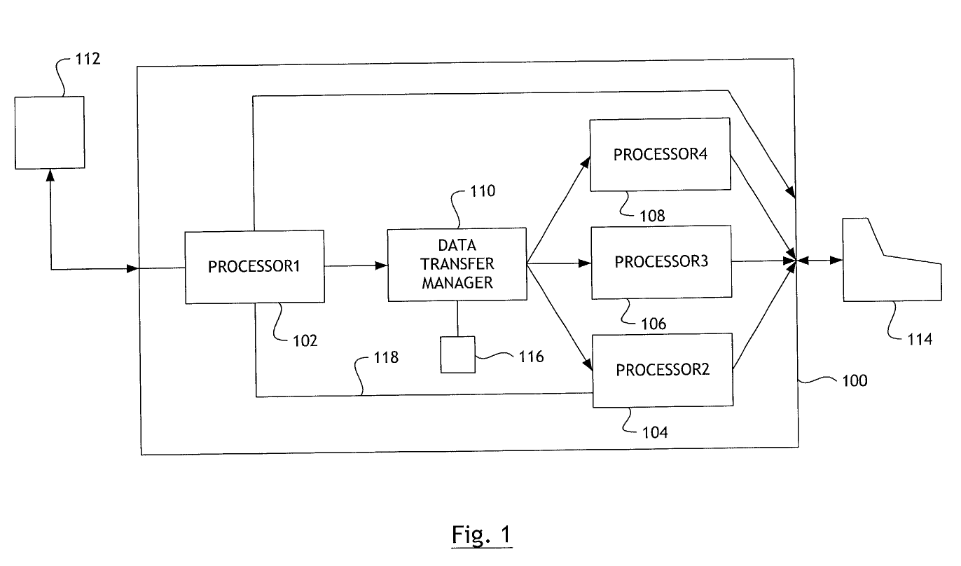

FIG. 1 depicts a simplified block diagram representation of a computer 100 that executes or runs four discrete data processing programs (also denominated as processors) 102, 104, 106 and 108 which are operatively coupled together through a data transfer manager 110. Insofar as FIG. 1 depicts a single computer 100, the processors 102, 104, 106 and 108 are separate computer programs (also known as applications) which process or operate on data to yield some usable result.

Data or information on which the processors (processes) operate on, can be obtained from a mass storage device such as a tape drive, disk drive, or electronic semiconductor memory all of which are considered to be equivalent and represented by the memory storage device identified in FIG. 1 by reference numeral 112. The output results of each of the processors (processes) 102, 104, 106 and 108 are made available from the computer 100 via a terminal or other output device such as a printer, cathode ray tube display, or other output device the particular identification of which is not germane to the invention disclosed and claimed herein but represented by the display terminal identified by reference numeral 114. As shown in FIG. 1, the results of the processing of data by any one of the processors can be displayed or made available through the output device 114.

In many data processing systems, there are often a number of physical and logical pathways between related and unrelated processes (or processors) along which or through which data can be transferred between the processors or processes. In some instances, a particular data processor 102 might receive data directly from a storage device 112 that will be encrypted and/or compressed. The data encryption and compression might be required for purposes of data or system integrity but nevertheless the processor 102 (i.e. a computer that executes the instructions of the process 102) needs to both decrypt and decompress such data prior to operating on it. In such a system, the first processor 102 is frequently required to send such data onto other processors 104, 106 and 108 and for either operating system requirements or security reasons or other reasons they need to first encrypt and/or compress or otherwise process the data before the first process (or processor) makes it available or sends it to the other processes (or processors) requiring it.

In other data processing systems, the computer 100 depicted in FIG. 1 can actually be a distributed array of separate computer devices 102, 104, 106 and 108 that are operatively linked together by different physical pathways and media and transmission protocols. In such systems, the physical media linking the computers as well as different data transmission protocols (e.g., TCP/IP, HTTP) used to transfer data between different computers will effectively provide different data transfer rates between different physical processors 102, 104, 106 and 108.

In order to optimize the data transferred between disparate computer processes or hardware processors 102, 104, 106 and 108 (the term data processor as used herein to refer to a physical computer or piece of hardware is used interchangeably with a computer program or application that is a data process insofar as the computer program operates on or processes data and is therefore also considered to be a processor) data transfers between both related and unrelated or disparate processors 102, 104, 106 and 108 can be realized if a data transfer manager 110 monitors various data transfer metrics between the various processors, records data transfer metrics over time and upon the accumulation of a sufficient number of data transfer metric samples, determines which of several different possible logical or physical pathways between the processors 102, 104, 106 and 108 is best. The determination of which pathway is best is made according to rules or criteria which determine the objective to be achieved by a data transfer pathway. By way of example, a data transfer rule might be to transfer large amounts of data at the lowest cost possible. Conversely, a different system owner might require that large data files be transferred over a media or pathway as fast as possible. In the former case, the rule would require that cost determine the best pathway; in the later case, speed would determine the best pathway. Optimum data transfers are accomplished by heuristically determining pathway transfer characteristics and selecting the pathway using (or according to) objective criteria referred to herein as rules.

In embodiments where the data transfer manager is a computer or processing device, (and which performs the function of monitoring data transfer pathways and recording data transfer metrics) such a device will execute a control program that monitors statistics such as data transfer rate, error rates, buffer overflows and under-runs and the like. Such indicators of a pathway's capacity are well known to those skilled in the art and are readily available from the data transfer circuitry and software that controls a data transfer. In such an embodiment, data transfer rules or parameters or algorithms can be stored in a separate memory device 116 operatively coupled to the data transfer manager computer 110 so as to enable the data transfer manager 110 to, at some point in time, effectuate subsequent data transfers between the processors, using only the optimum data transfer pathway.

If the data transfer manager is a computer program running in a computer wherein data does not need to traverse switching systems or transmission media, the transfer manager program will largely need to monitor times at which a file is requested and when it is sent; the time required to transfer control or physical delivery of data. Such a program will also need to track processing overhead, such as whether encryption, compression or other overhead needs to be taken care of before a data item is made available to one program from another.

When data transfer metrics are determined, the optimum data transfer pathway can be determined using the data transfer rules or requirements in combination with the data acquired over time by the data transfer manager. In a single computer, wherein data might be transferred between processes faster, less processing capacity is wasted on unnecessary overhead program execution. In a multi-computer distributed network of computers, selecting the appropriate transfer pathway can avoid unnecessary costs in some instances and avoid unnecessary delays in others.

By way of example, if the computer 100 depicted in FIG. 1 is a stand alone single computer having a simple processor unit, and if the processors 102, 104, 106 and 108 represent separate computer programs that might execute concurrently under a multi-tasking operating system or which might operate individually in sequence, the first processor 102 might be a computer program which calculates income tax liability of an employee or employees and yields a numerical result or results for an employer as to the amount of salary or wages that should be withheld and paid to the Government as required by law. In order to calculate tax liability for an employee, the processor 102 will need to access various data records from memory 112, which would include the employee's wage or salary rate and the number of hours worked by the employee over some period of time. Once the processor 102 is complete, its output might be directed to a suitable output device 114 for use by the computer user.

As part of a large payroll or benefits program however the information operated on by the processor 102 to compute tax liability might also be required by another processor 104 to determine or calculate the employees eligibility for certain benefits. Inasmuch as an employee might need to work a certain minimum number of hours per pay period in order to qualify for health or other benefits, the processor 104 will also require access to the same data used by the processor 102 to compute tax liability. Accordingly, processor 102 preferably transfers employee data that it operated on, directly to processor 104 without first saving the data back onto a memory device 112 and perhaps including along the way, unnecessary formatting, encryption or compression algorithms required to save the data onto the storage device 112.

In order to transfer the employee data from the processor 102 to the processor 104, prior art transfer methodologies in a large data processing system frequently would require processor 102 to encrypt the data or compress the data or otherwise wrap layers of control or formatting around it prior to the transfer to processor 104. The additional operations of a processor 102 on the data can in effect be considered a virtual pathway in that certain steps are followed prior to the physical or virtual transfer of control of the data from the processor 102 to the processor 104. In such a pathway, the data might not physically leave the computer 100 but would require certain operations to be performed on it before it could be transferred to or made available to processor 104 by processor 102.

An alternative pathway between processor 102 and 104 might be a direct logical or physical transfer of the data between the processors 102 and 104. In such a data transfer, the processing overhead required by the computer 100 is significantly reduced.

By employing a data transfer manager 110 to monitor the various pathways between different processors, the data transfer manager can accumulate objective data on the time or processing required to transfer data (or its availability both of which are considered to be equivalent data “transfers”) between the two disparate processors 102 and 104. The data transfer manager 110, in a single computer 100 such as that depicted in FIG. 1 preferably is embodied as a computer program that tracks various data transfer pathway metrics. The data transfer manager 110 can be implemented to record the CPU time required to compress and encrypt data and then transfer logical or physical control of that encrypted and compressed data to processor 104 as opposed to a direct transfer of control without having to perform the other steps of compression and encryption.

In an embodiment where the computer 100 is actually a distributed network of separate computer processors, i.e. hardware, the data transfer manager would be embodied as a computer or other type of a computer device that monitors the data transfer pathway metrics associated with different physical media linking the different processors 102, 104, 106 and 108 together.

By way of example, if the computer 100 shown in FIG. 1 is actually a depiction of a computer network, the data transfer manager 110 will track the data transfer rate between a physical processor 102 and another processor 104 via the physical media 118 that links the physical processors 102 and 104 together. The physical media 118 might in some instances be a fiber optic cable or a dial up telephone connection the data transfer rates between them differing by perhaps several orders of magnitude. The data transfer manager 110 might also monitor different data transfer rates of different data transfer protocols such as TCP/IP versus HTTP. The data transfer manager 110 might track data transfer rates across media 118 that might be an ATM or a synchronous transfer mode network as opposed to a synchronous switching network (not shown).

The physical media 118 linking two different processors could also include secure versus unsecure connections, leased lines at high data rates as opposed to relatively inexpensive dial up connections.

Considering the number of different pathways between separate processors, the data transfer manager's task is to track various parameters associated with data transfers between either physical or virtual processors (computers or programs) and in so doing, measurable data transfer metrics. Once the various metrics of the various pathways between processors have been determined, the data transfer manager thereafter directs data transfers between the processors using an optimum data transfer pathway the identity of which is determined according to rules, objectives or requirements established by a user and stored in memory 116 for consultation by the data transfer manager 110.

The rules (or parameters or objectives) can include but are not limited to requiring that data transfers between processors be accommodated by the highest possible data transfer rate; be accomplished by the most secure data pathway (i.e. a leased line) or by the least costly or most inexpensive connection. Further complexities to the rules might include conditions that require that very large data files be transferred using a most economical pathway whereas small highly sensitive data be transferred using the most rapid pathway that is the most secure.

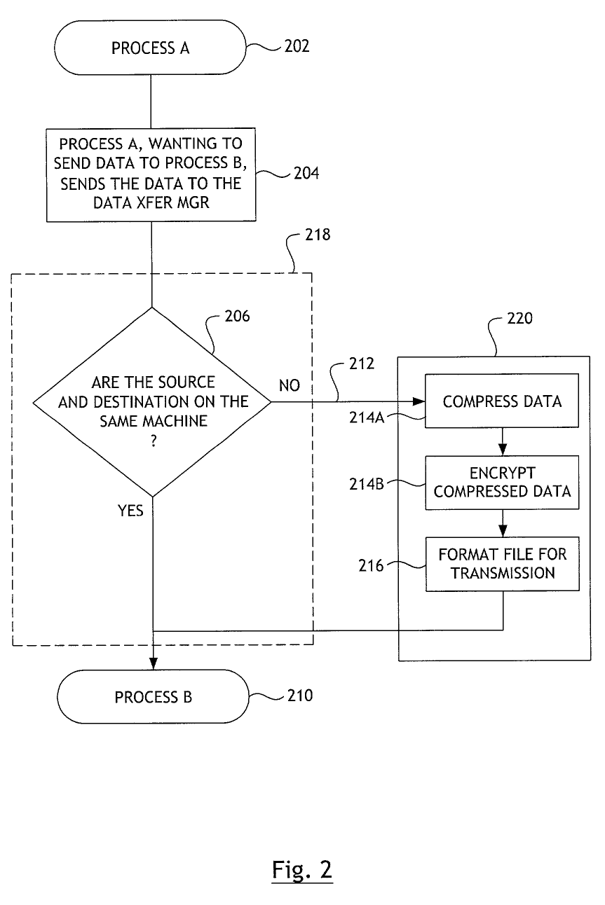

FIG. 2 shows a simplified block diagram showing steps that the data transfer manager 110 would follow to determine the optimum data transfer pathway for a first process A to transfer data to a second process B. Upon the conclusion of process A's operation on various data in step 202, process A determines, or is required by either another process or process B to transfer the data to process B in step 204. In step 204, process A sends the data to the data transfer manager. In step 206, the data transfer manager makes the determination as to whether or not process A and process B are programmed on the same physical machine. Upon the determination that process A and process B, which both operate on the same data are on the same machine the data transfer manager sends the data directly to process B in step 208 whereupon process B can operate on the data as it needs to in step 210.

If the data transfer manager 110 determines in step 206 that process A and process B are not on the same physical computer, a direct transfer from process A to process B is therefore not possible. In such a case, the data must be sent out of the first computer into the second, following rules, which for purposes of this illustration require that the data be first compress and encrypted. Accordingly, in “step” 212, the data transfer manager 110 sends the data to be transferred to various engines or processes 214A, 214B and 216. Encryption engine 214A is shown in FIG. 2 as a process (or program) that suitably compresses a file or data and in the embodiment shown in FIG. 1 would compress data or a file prior to its transfer to another process, which in FIG. 2 is denominated as Process B. Engine 214B is shown in FIG. 2 as encrypting the compressed data. Engine 216

It can be seen in FIG. 2, that the exchange of data from process A to process B as two distinct different pathways 218 and 220. Pathway 218 can be implemented as a logical control transfer on a single processor of the data required by process A and process B. A separate pathway 220 is required when process A and process B are on disparate computers requiring the data to be physically sent over some external transmission media coupling the two computers together. In such a case, the pathway 220 includes various processing overhead steps that include the encryption 214 and the physical transfer 216 that might include various data formatting and data protocol processing steps adding to the complexity and time required to accomplish the data transfer between process A and process B. Other logical or physical pathways would include other processing steps or transmission media and could be selected for usage by a data transfer manager according to rules (or requirements) established by a system user.

If the pathway 220 depicted in FIG. 2 can be accomplished using different physical media between the two computers, the data transfer manager can, by recording the performance characteristics of different pathways, determine which is optimum to send subsequent data transfers over.

If the data transfer manager is provided with rules that define or specify data transfer requirements, the data transfer manager can choose to send a particularly large file for example over a low cost media if timely delivery is not of the essence. Conversely, a small file with very complex data or sensitive data might be sent over a very costly highly secure pathway in order to ensure its delivery and integrity along the way.

By employing a data transfer manager, which can be implemented as a computer program to track and record data transfer metrics and apply those metrics using user-defined rules, data transfers between different processes in a single computer can be optimized. Similarly, data transfers between separate computers can also be optimized if the various data pathways existing between the computers are evaluated using objective transfer metrics. The data transfer metrics in combination with user-specified data transfer rules or objectives can be used to objectively control and identify the optimal data transfer pathway between the separate computers.

What is claimed is:

1. A method for transferring data between first and second data processing applications, both of which operate on said data, said method comprised of the steps of:
measuring a first data transfer metric for a first data transfer pathway between said first process and said second process;
measuring said first data transfer metric for a second data transfer pathway between said first process and said second process;
comparing the first data transfer metric for the first pathway to the first data transfer metric for the second pathway;
selecting one of said first and second data transfer pathways for subsequent data transfers based upon the result of said step of comparing, and upon at least one user-specified data transfer rule.

2. The method of claim 1 wherein at least one of said first and second data transfer pathways are comprised of at least one computer program.

3. The method of claim 1 wherein at least one of said first and second data transfer pathways is a physical transmission media.

4. The method of claim 1 wherein said at least one user specified data transfer rule includes at least one of: a data transmission pathway data transfer rate; a data transmission pathway cost; a data transmission pathway processing overhead.

5. A method for transferring data between first and second data processors which operate on said data, said method comprised of the steps of:
measuring a first data transfer metric for a first data transfer pathway between said first processor and said second processor;
measuring said first data transfer metric for a second data transfer pathway between said first processor and said second processor;
comparing the first data transfer metric for the first pathway to the first data transfer metric for the second pathway;
selecting one of said first and second data transfer pathways for subsequent data transfers between said first and second processors based upon the result of said step of comparing, and upon at least one user-specified data transfer rule.

6. The method of claim 5 wherein at least one of said first and second data transfer pathways are comprised of at least one computer program.

7. The method of claim 5 wherein at least one of said first and second data transfer pathways is a physical transmission media.

8. The method of claim 5 wherein said at least one user specified data transfer rule includes at least one of: a data transmission pathway data transfer rate; a data transmission pathway cost; a data transmission pathway processing overhead.

9. A method for transferring data between first and second data processing applications, both of which operate on said data, said method comprised of the steps of:
measuring first and second data transfer metrics for a first data transfer pathway between said first process and said second process;
comparing said first and second data transfer metrics;
selecting first data pathway for subsequent data transfers based upon the result of said comparing and upon at least one user-specified data transfer rule

10. The method of claim 9 wherein at least one of said first and second data transfer pathways are comprised of at least one computer program.

11. The method of claim 9 wherein at least one of said first and second data transfer pathways is a physical transmission media.

12. The method of claim 9 wherein said at least one user specified data transfer rule includes at least one of: a data transmission pathway data transfer rate; a data transmission pathway cost; a data transmission pathway processing overhead.

13. A computer system that minimizes data transfer operations, comprising:
a data network having a plurality of data transfer pathways through which data is transferred;
at least first and second processors coupled to said network;
a data transfer manager coupled to the first and second processors and coupled to the data network, said data transfer manager determining data transfer metrics of a plurality of data transfer pathways through said network, said data transfer manager determining the data transfer pathways through said network through which subsequent data transfers occur.

14. The computer system of claim 13 wherein the predetermined data transfer manager limits transfer of data requested based on at least one of the preselected transfer attributes.

15. The computer system of claim 13 wherein said data transfer manager is a computer.

16. The computer system of claim 13 wherein said data transfer manager is a computer program.
